(19) United States
(12) Patent Application Publication
(10) Pub. No.: US 2025/0285121 A1
(43) Pub. Date: Sep. 11, 2025

(54) SYSTEMS AND METHODS FOR EMISSIONS DATA ANALYSIS WITH MACHINE LEARNING MODELS

(71) Applicant: Cyberspace Creations LLC, Dover, DE (US)

(72) Inventor: Frank CHEN, Oakland, CA (US)

(73) Assignee: Cyberspace Creations LLC, Dover, DE (US)

(21) Appl. No.: 18/958,470

(22) Filed: Nov. 25, 2024

Related U.S. Application Data
(60) Provisional application No. 63/563,471, filed on Mar. 11, 2024.

(51) Int. Cl. G06Q 30/018; G06N 20/00

(52) U.S. Cl. CPC G06Q 30/018; G06N 20/00

(57) ABSTRACT

Disclosed herein are systems, methods, and media for emissions data analysis. The disclosed embodiments include accessing emissions activity data from at least one emissions activity data source. The emissions activity data may correspond to an entity and the at least one emissions activity data source corresponds to an activity region. The disclosed embodiments include extracting structured emissions data from the emissions activity data by applying the emissions activity data to a machine learning model configured to standardize data. The machine learning model may be trained with emissions training data. The disclosed embodiments include accessing an emissions factor database containing a plurality of emissions factors. The disclosed embodiments include selecting, from the emissions factor database, at least one emissions factor corresponding to the activity region. The disclosed embodiments include generating an emissions line item based on the structured emissions data and the at least one selected emissions factor.

### CROSS-REFERENCE TO RELATED APPLICATIONS

This application claims priority to and the benefit of U.S. Provisional Application No. 63/563,471, titled “System and Method for Multiregional Analysis of Greenhouse Gas Emissions from Business Data,” filed Mar. 11, 2024. The disclosure of the above-referenced application is expressly incorporated herein in its entirety.

### FIELD OF DISCLOSURE

The disclosed embodiments generally relate to systems, devices, methods, and computer readable media for processing and analyzing emissions data.

### BACKGROUND

Traditional or conventional data analysis platforms may be used to analyze some emissions data, such as greenhouse gases (GHGs). However, conventional systems may be inefficient and/or inaccurate in ingesting, analyzing, and processing emissions data including large amounts of data in various formats. For example, databases may store emissions data in different file formats, and conventional systems may not be able to efficiently comprehend and extract the relevant data to generate insights from the data. Further, conventional systems for understanding and mitigating emissions often lack the ability to handle different emissions regulations or emissions in different regional boundaries. As such, conventional systems are often unable to generate comprehensive emissions insights.

### SUMMARY

Some disclosed embodiments include a machine learning system for emissions data analysis. In some embodiments, the system includes at least one processor and at least one computer-readable medium containing instructions that, when executed by the at least one processor, cause the machine learning system to perform operations. In some embodiments, the operations include accessing emissions activity data from at least one emissions activity data source. The emissions activity data may correspond to an entity and the at least one emissions activity data source may correspond to an activity region. In some embodiments, the operations include extracting structured emissions data from the emissions activity data by applying the emissions activity data to a machine learning model configured to standardize data. The machine learning model may be trained with emissions training data. In some embodiments, the operations include accessing an emissions factor database containing a plurality of emissions factors. In some embodiments, the operations include selecting, from the emissions factor database, at least one emissions factor corresponding to the activity region. In some embodiments, the operations include generating an emissions line item based on the structured emissions data and the at least one selected emissions factor.

According to some disclosed embodiments, the emissions factor database includes a public database.

According to some disclosed embodiments, the emissions factor database corresponds to an emissions schema.

According to some disclosed embodiments, the emissions factor database includes a proprietary database or the at least one emissions factor includes a proprietary emissions factor.

According to some disclosed embodiments, the operations further include identifying the emissions factor database with the machine learning model and selecting, with the machine learning model, the at least one emissions factor from the identified emissions factor database.

According to some disclosed embodiments, the operations further include receiving an identification of the emissions factor database from a user interface and selecting the at least one emissions factor from the identified emission factor database based on an input received from the user interface.

According to some disclosed embodiments, the emissions training data may be entity-specific, and the emissions training data may include at least one of emissions entity training data or emissions activity training data.

According to some disclosed embodiments, training the machine learning model may include obtaining the emissions training data, receiving user input from a user interface, and updating the machine learning model based on the emissions training data and the user input.

According to some disclosed embodiments, the operations include generating a user interface and displaying the generated emissions line item on the user interface.

According to some disclosed embodiments, the operations include selecting, from the emissions factor database, emissions factors corresponding to a plurality of activity regions, and generating emissions line items based on the structured emissions data and the plurality of selected emissions factors.

Other systems, methods, and computer-readable media are also discussed herein. Disclosed embodiments may include any of the above aspects alone or in combination with one or more aspects, whether implemented as a method, by at least one processor, and/or stored as executable instructions on non-transitory computer readable media.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 illustrates a block diagram of system 100 for analyzing emissions data, consistent with embodiments of the present disclosure.

FIG. 2 illustrates a block diagram of an emission data workflow 200, consistent with embodiments of the present disclosure.

FIG. 3 illustrates a block diagram of a training workflow, consistent with embodiments of the present disclosure.

FIGS. 4A-4E illustrate exemplary user interfaces for emissions insights, consistent with embodiments of the present disclosure

FIG. 5 illustrates a method for analyzing emissions data and generating emissions insights, consistent with embodiments of the present disclosure.

FIG. 6 is a block diagram illustrating an exemplary operating environment for implementing various aspects of this disclosure, consistent with embodiments of the present disclosure.

FIG. 7 is a block diagram illustrating an exemplary machine learning platform for implementing various aspects of this disclosure, consistent with embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. In the following detailed description, numerous specific details are set forth in order to provide a thorough understanding of the disclosed example embodiments. However, it will be understood by those skilled in the art that the principles of the examplary embodiments may be practiced without every specific detail. Well-known methods, procedures, and components have not been described in detail so as not to obscure the principles of the example embodiments. Unless explicitly stated, the example methods and processes described herein are neither constrained to a particular order or sequence nor constrained to a particular system configuration. Additionally, some of the described embodiments or elements thereof can occur or be performed (e.g., executed) simultaneously, at the same point in time, or concurrently. Reference will now be made in detail to the disclosed embodiments, examples of which are illustrated in the accompanying drawings.

It is to be understood that both the foregoing general description and the following detailed description are exemplary and explanatory only and are not restrictive of this disclosure. The accompanying drawings, which are incorporated in and constitute a part of this specification, illustrate several exemplary embodiments and together with the description, serve to outline principles of the exemplary embodiments.

This disclosure may be described in the general context of customized hardware capable of executing customized preloaded instructions such as, e.g., computer-executable instructions for performing program modules. Program modules may include one or more of routines, programs, objects, variables, commands, scripts, functions, applications, components, data structures, and so forth, which may perform particular tasks or implement particular abstract data types. The disclosed embodiments may also be practiced in distributed computing environments where tasks are performed by remote processing devices that are linked through a communications network. In a distributed computing environment, program modules may be located in local and/or remote computer storage media including memory storage devices.

The disclosed embodiments may provide improvements to the ingestion and analysis of emissions data. Processing emissions data may be a computationally-complex task, as it may involve analyzing large amounts of data which can be stored in a variety of formats and/or sources. Processing emissions data may involve analyzing such large amounts of data over various time frames (e.g., over a few days, months, or several years). Emissions data may be stored in a variety of formats, including different types of documents, various invoices, accounting systems, sensors, or manually-entered data. Further, emissions data can be received in both structured or unstructured formats and may be reported in different units. In addition, the computationally-complex nature of processing and extracting emissions data may be exacerbated at scale. For example, analyzing emissions data can range from analyzing a single emissions source to analyzing emissions for a large company having hundreds of offices or thousands of vehicles. The disclosed embodiments may enable standardization of emissions data from differing sources and formats, thereby improving the processing of emissions data.

In addition, the disclosed embodiments may provide improvements to the generation of insights from emissions data in order to mitigate emissions. As emissions protocols, scopes, or regulations may differ depending on the type of emission, source of emission, or region, it may be difficult to understand emissions data. The disclosed embodiments may process, structure, and analyze data to generate emissions insights, which can be used for accounting, measuring, or reporting emissions. Further, the disclosed embodiments involve generating insights for reducing or mitigating emissions such as greenhouse gases. The disclosed embodiments may improve upon the functioning of machine learning systems by improving the training of such systems and their ability to handle emissions data. For example, the disclosed embodiments may provide improvements to the training and inference of machine learning models used to standardize emissions data.

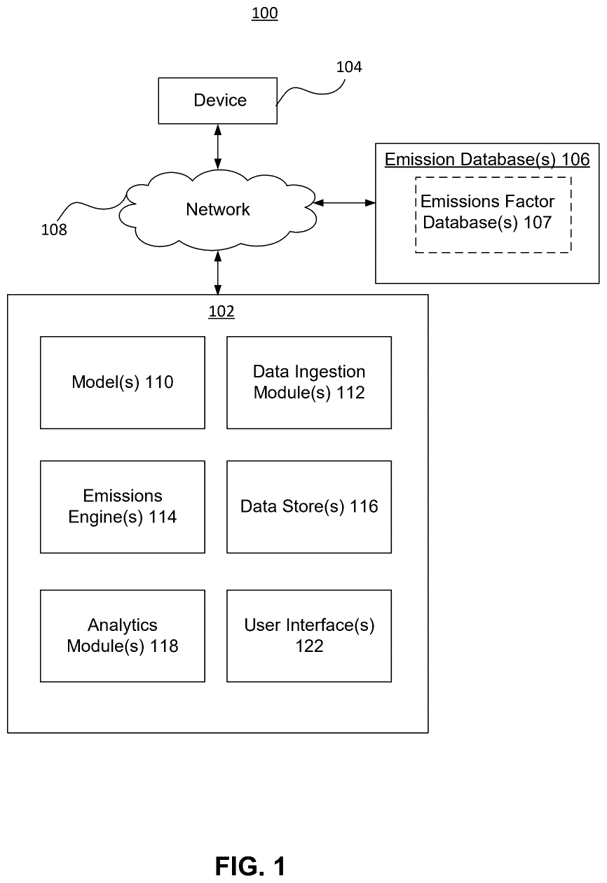

FIG. 1 illustrates a block diagram of a system 100 for analyzing emissions data, consistent with embodiments of the present disclosure. Emissions data may include any information about substances released or discharged into the environment. Emissions data may involve the amounts and/or types of chemicals, pollutants, or greenhouses gases released into air, water, or the ground. In some embodiments, emissions data may include emissions activity data. Emissions activity data may be emissions data corresponding to one or more actions or activities (e.g., an emissions activity). Emissions activity data may refer to a specific operation or activity resulting in emissions. For example, emissions activity data may include the emissions caused by using electricity in an office building for one hour or the amount of greenhouse gases released from fuel consumed for driving a car. System 100 may include application system 102, device 104, and emission database(s) 106 in electronic communication via network 108. In some embodiments, device 104 may include any device for interacting with data such as emissions data. Device 104 may be configured to receive, obtain, access, generate, or transmit emissions data including emissions activity data. For example, device 104 may be a device capable of interacting with a user, such as a phone, tablet, computer system, or the like. Device 104 may access documents containing emissions activity data, such as utility bill, purchase invoice, or shipping manifest received by device 104. For example, device 104 may refer to an application programming interface (API) or web portal that a user may upload an invoice to. Additionally, or alternatively, device 104 may be a sensor or meter. For example, device 104 may be a sensor which measures emissions activity data from a building or an Internet of Things (IoT) sensor. In some embodiments, application system 102 may be capable of integration with external systems, such as enterprise resource planning or supply chain management software. Application system 102 may include various frameworks for integration with external systems.

In some embodiments, application system 102 may include machine learning model(s) 110, data ingestion module(s) 112, emissions engine(s) 114, data store(s) 116, analytics module(s) 118, and user interface(s) 120. Machine learning model(s) 110 may include any model that can extract and/or standardize data, including text or image data. For example, machine learning model(s) 110 may include neural networks, transformers, encoders, regression models, support vector machines, nearest-neighbor models, as well as clustering models, as non-limiting examples. In some embodiments, machine learning model(s) 110 may include language models, large language models, or multimodal models (e.g., models that can process or generate, images, and videos). In some embodiments, machine learning model(s) 110 may include an endpoint for requests to a machine learning model, such as an API call to a machine learning model. Data ingestion module(s) 112 may assist in processing structured and/or unstructured data. Data ingestion module(s) 112 may parse inputs into text and/or metadata. For example, data ingestion module(s) 112 may perform optical character recognition (OCR) for scanning documents such as PDFs. In some embodiments, data ingestion module(s) 112 may receive data from device 104. Additionally, or alternatively, data ingestion module(s) 112 may include models of machine learning model(s) 110. Emissions engine(s) 114 may calculate or generate emissions data from emissions activity data. For example, emissions engine(s) 114 may calculate emissions totals based on emissions activity data and emissions factors. In some embodiments, emissions engine(s) 114 may utilize rule-based logic for generating emissions data. Data store(s) 116 may store extracted data (e.g., from data ingestion module(s) 112) or emissions data (e.g., from emissions engine(s) 114). Data store(s) 116 may include a distributed data storage architecture to enable data residency and compliance with location-based regulations. For example, data store(s) 116 may store data within a region of origin (e.g., within North America, Europe, or Asia, or within specific countries or states) to facilitate compliance with regional data residency regulations. Data store(s) 116 may include encryption methods or access control mechanisms for data. For example, application system 102 may encrypt data at rest or in transit, and data store(s) 116 may provide role-based access control to data. In some examples, data store(s) 116 may be compliant with data protection regulations, such as regional-based regulations (e.g., GDPR or CCPA). Analytics module(s) 118 may analyze emission data to generate insights and reports. For example, analytics module(s) 118 may calculate key performance indicators (KPIs) by emission scope, region, business unit, and other dimensions, or provide benchmarking capabilities against industry peers. Analytics module(s) 118 may identify trends, anomalies, and opportunities for emissions reductions. For example, analytics module(s) 118 may generate simulations for projected emissions based on scenario modeling and planning, allowing a user to adjust parameters such as activity levels, emissions factors, business changes, and reduction initiatives to assess impacts on future emissions, as well as providing target-setting, forecasting, and decision-making on sustainability initiatives. In another example, analytics module(s) 118 may provide access for third-party auditors to verify emissions data and calculations, such as by providing read-only access as well as the ability to generate detailed audit trails, logs, or data snapshots to facilitate streamlined audit processes and enhance transparency. User interface(s) 122 may include web portals or graphical user interfaces to interact with emissions data. For example, user interface(s) 122 may include interactive dashboards or other data visualizations. In some embodiments, user interface(s) 122 may generate workflows or interfaces for device 104, such as a portal for uploading, validating, or reviewing emissions activity data to device 104.

In some embodiments, emissions database(s) 106 may include a collection of information such as a database, repository, or website storing emissions data. Emissions database(s) 106 may include public databases having publicly-accessible data. For example, emissions database(s) 106 may include government or regulatory databases (e.g., Environmental Protection Agency, European Environment Agency, or International Council on Clean Transportation data) as well as commercial or public databases (e.g., Google maps software or company databases such as Bloomberg). Emissions database(s) 106 may also include private (e.g., proprietary), or customized databases. For example, emissions database(s) 106 may include a company's internal database containing information about emission entities (e.g., number of offices, types of equipment) or an automaker's database for emissions on various makes or models. In some embodiments, emissions database(s) 106 may include one or more emissions factor database(s) 107. An emissions factor may be a value or coefficient used to convert activity data into emissions, such as greenhouse gas emissions. An emissions factor may quantify the amount of a specific pollutant or greenhouse gas released into the atmosphere as a result of an emission activity. Emissions factor database(s) 107 may include one or more emissions factors, including public emissions factors and/or private emissions factors. For example, emissions factor database(s) 107 may include a public database with public emissions factors, such as an emissions factor published by the Department for Environment Food and Rural Affairs (e.g., “Purchased electricity. Dataset: 2013, DEFRA. Region: US. Unit: kWh”). Additionally, or alternatively, emissions factor database(s) 107 may be a proprietary (e.g., private or confidential) database including one or more proprietary emissions factor. For example, emissions factor database(s) 107 may include a custom emissions factor created for a specific organization.

In some embodiments, application system 102 may include versioning capabilities. For example, application system 102 may include version control software. Machine learning model(s) 110 may include version controls for model parameters or hyperparameters. Emissions engine(s) 114 may include data versioning for emissions datasets, such as historical changes to emissions datasets. Data ingestion module(s) 112 may include versioning for data updates, such as updates to emissions sources. Analytics module(s) 118 may include data versioning for audit functionalities, such as tracking changes or providing reproducibility for audits. In some embodiments, versions may be stored in data store(s) 116. Additionally, or alternatively, application system 102 may implement versioning with repositories for version control (e.g., application system 102 may be connected over network 108 to a remote repository). In some embodiments, application system 102 may support multi-language reporting capabilities, such as with internationalization (i18n) framework for user interface elements (e.g., for user interface(s) 122), localization support for emissions data formatting (e.g., providing appropriate units or date formats depending on region), or language-specific regulatory compliance. In some embodiments, application system 102 may include API functionality or documentation. For example, application system 102 may support authentication and authorization mechanisms for API access. Exemplary API features may include endpoints for document upload and processing (e.g., for ingestion module(s) 112), endpoints for CRUD (create, read, update, delete) operations (e.g., corresponding to data store(s) 116 or emissions engine(s) 114), as well as rate limiting or error handling for API requests.

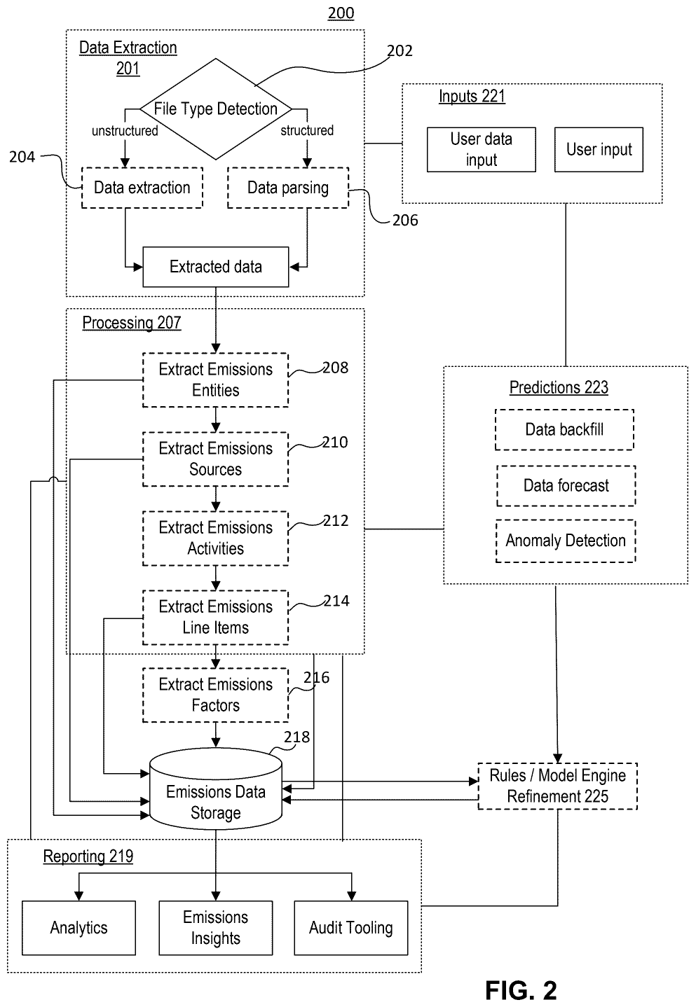

Fig. 2 illustrates a block diagram of an emission data workflow 200, consistent with embodiments of the present disclosure. In some embodiments, workflow 200 may include a step 201 of structured data extraction. Step 201 may involve NLP techniques, OCR, vectorization (e.g., featurization), or the like. In some examples, extracting structured data may involve a step 202 of file type detection, such as determining the type or format of inputs containing emissions activity data. If the detected file includes unstructured data, step 204 may involve extracting structured data from unstructured data. For example, ingestion module(s) 112 and/or machine learning model(s) 110 may assist in data extraction of unstructured data, such as extracting emissions data from a shipping manifest. Additionally, or alternatively, the disclosed embodiments may include a step 206 of data extraction for structured data by parsing structured data. For example, structured data may include emissions data from utility bills or fuel purchase invoices. It will be recognized that extracted data may lack uniformity, such as data that may originate from different file formats, use different units, report different measures, or use different metrics, as described herein. Furthermore, extracted emissions data may include large amounts of data. As such, it may be difficult to generate insights from such data, and processing such data with conventional systems may involve high computational bandwidth. Some disclosed embodiments include extracting structured data, which may involve standardizing or normalizing data. Structured or unstructured data may be applied to a machine learning model of machine learning model(s) 110, and the machine learning model may convert the data to structured emissions data. For example, a multimodal model may standardize data to have consistent units, dates or time periods, as well as consistent emissions metrics, types, or factors. It will be appreciated that by extracting standardized emissions data, the disclosed embodiments may reduce the computational load involved in processing or analyzing emissions data.

Workflow 200 may include a step 207 of processing extracted emissions data. In some embodiments, processing may involve a step 208 of extracting emission entities. An emissions entity may include an organization, facility, or piece of equipment that can generate emissions. For example, an emissions entity may be a building associated with an address or a vehicle in a fleet. Extracting emissions entities may involve identifying, obtaining, or retrieving, emissions entities from emissions data, such as identifying a factory from a utility invoice. For example, extracting an emissions entity may include extracting the address for a facility from a gas bill. Workflow 200 may include a step 210 of extracting emissions sources. Emissions sources may include processes that release GHGs corresponding to a given emissions scope. Emissions sources may be categorized into different scopes (e.g., based on sources, operational boundaries, or the influence an organization may have on the emissions). For example, emissions scopes may include Scope 1—direct emissions from owned or controlled sources, Scope 2—indirect emissions from purchased energy, and Scope 3—other indirect emissions. An example of an emissions source may be “purchased electricity—Scope 2.” Workflow 200 may include a step 212 of extracting emissions activities. For example, emissions activity data may be extracted from a utility bill as the amount of emissions, and the extracted emissions activity data may be the emissions caused by using electricity in an office building for one hour or the natural gas consumption for heating a building. Workflow 200 may include a step 214 of extracting emissions line items. An emissions line item may be a quantitative measure of emissions activities for a certain time period For example, an emissions line item may include the liters of fuel used for a specific task for a given number of hours, the natural gas usage (e.g., measured in British Thermal Units) for a given month, or the kilowatt-hours of electricity consumed for an operation with a start date and end date. Workflow 200 may include a step 216 of extracting emissions factors. In some embodiments, emissions factors may be extracted from a database, such as a public or private database as described herein. Additionally, or alternatively, emissions factors may be extracted from files containing emissions data. For example, a utility bill may include an emissions factor corresponding to the location or region of the emission activity. In some embodiments, workflow 200 may include a step 218 of storing emissions data. For example, step 218 may include structured emissions data, emissions entities data, emissions source data, emissions activity data, emission line items, or emissions factors. Step 218 may include storing data in a data store of data store(s) 116, as described herein.

In some embodiments, workflow 200 may include a step 219 of reporting. Step 219 may involve analyzing emission data and providing analytics to a user, such as through a user interface. For example, step 219 may include reporting analytics, such as analyses of extracted emission entities or emissions sources, by providing the analytics to a user interface of user interface(s) 122. Step 219 may also include reporting emissions insights. For example, step 219 may involve generating emissions insights corresponding to past or future trends in emissions as well as options to reduce emissions based on extracted emissions data. Step 219 may also involve reporting audit tools. For example, step 219 may provide reports such as audit logs for emissions. In some embodiments, step 219 may involve reporting aggregate emissions data. Aggregate emissions data may include emission data aggregated or combined, such as an entity's total emissions data for a given time period. Aggregate emissions data may be sliced or broken into subsets in order to generate emission insights. For example, step 219 may involve displaying aggregate emissions for a facility sliced by scope (e.g., displaying total emissions as well as the relative amounts of emissions corresponding to Scope 1, Scope 2, or Scope 3).

In some embodiments, workflow 200 may involve a step 221 of applying inputs. Input or feedback may enhance various steps in workflow 200. Step 221 may include applying inputs or feedback (e.g., provided by a user) to refine data extraction or data processing steps in workflow 200. For example, feedback received through a user interface may be used to improve OCR tools used in step 202 for file type detection, or user inputs may be used to improve machine learning models that extract emissions activities in step 212. Additionally, or alternatively, step 221 may involve applying training data or validation data to steps in workflow 200.

In some embodiments, workflow 200 may involve a step 223 of generating predictions. Predictions may be generated based on extracted emissions data or from emissions analytics or emissions insights. For example, generating predictions may involve generating data backfill and/or generating data forecast. Backfill may refer to retroactively, processing, completing, or filling in data points in a dataset. Backfill may involve filling in missing data points in a series of historical data points. For example, backfill may involve replacing or adding emissions data for a facility for a given month over the course of a year (e.g., for emissions data with some months missing, backfill may include generating emissions data for the missing months). Forecasting may refer to generating predictions or simulations for future data. For example, forecasting may involve adding data points based on trends, such as generating a prediction for a future month's emissions data for a facility based on previous data in the year. In some embodiments, machine learning model(s) 110 may assist in simulations such as forecasting or backfill. For example, regression models, time series models, unsupervised learning models, or the like may detect missing data for emissions data, such as an missing month in a year. Additionally, deep learning models, LSTM models, regression models, or the like may capture relationships in existing emissions data to forecast future data. In some embodiments, forecasting may include generating predictions for various scenarios, such as comparing the cost effectiveness or emission mitigations for different emissions reductions scenarios. In some embodiments, step 223 may include anomaly detection. Anomaly detection may include the identifying or determining outliers in emissions data. For example, anomaly detection may involve statistical methods, such as standard deviation-based methods (e.g., Z-score), Local Outlier factor, Hampel filter, or the like. Additionally, or alternatively, anomaly detection may include machine learning models as described herein, such as any model capable of pattern recognition or anomaly detection. For example, an autoencoder model may be used to detect outlier data points, such as an outlier month in a year.

In some embodiments, workflow 200 may involve a step 225 of refinement. Step 225 may involve refining machine learning models or rule-based logic used for data extraction and/or data generation, as described herein. For example, step 225 may involve training a machine learning model (e.g., of machine learning model(s) 110) or updating logic (e.g., for emissions engine(s) 114) based on inputs received in step 219. Step 225 may involve a rules/model engine, which may include a machine learning model that can understand rule-based logic to assist in making decisions about data validity or data processing. In some embodiments, machine learning models may be trained with emission training data. Step 225 may involve also involve updating models based on data from an emissions data store. In some embodiments, emissions training data may be entity-specific. For example, emissions training data may include data corresponding to a single entity, such as an individual facility, or a group of related entities, such as a vehicle fleet.

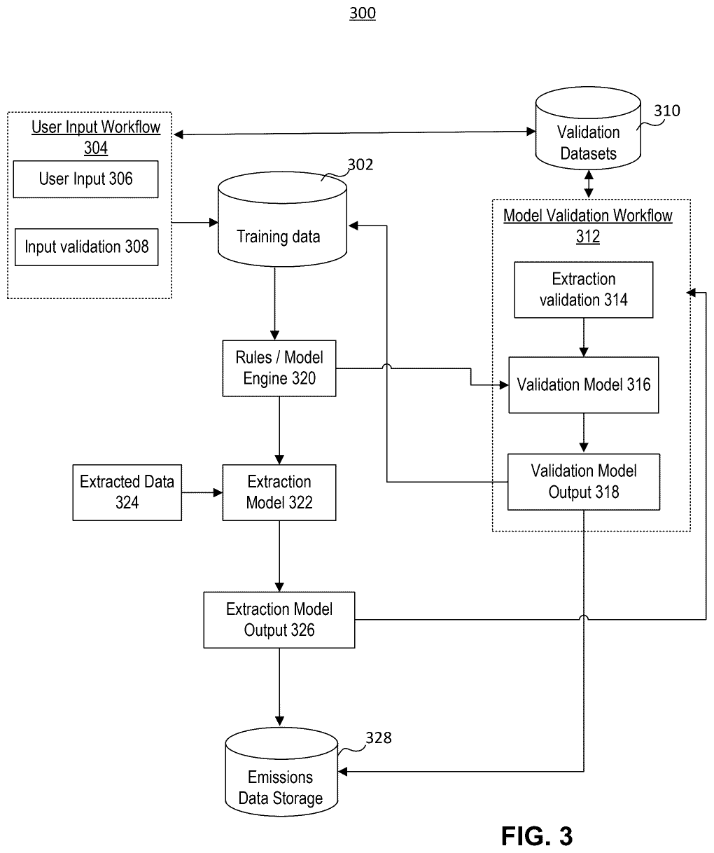

FIG. 3 illustrates a block diagram of a training workflow 300, consistent with embodiments of the present disclosure. Workflow 300 may illustrate the flow of information for training some machine learning models described herein, including models of machine learning model(s) 110. Training machine learning models may include updating or refining a model. For example, workflow 300 may assist in training a machine learning model (e.g., of model(s) 110) configured to standardize and/or extract data, as described herein. In some examples, training a machine learning model may involve updating parameters, layers, or weights of the model. In some embodiments, models may be trained with training data 302, which may include emissions training data. Emissions training data may include any emissions data that can be used to train a machine learning model. In some embodiments, emissions training data may include data corresponding to emissions activity, emissions entities, emissions sources, emissions factors, or emissions line items. Workflow 300 may include validation of training inputs for machine learning models, including training data 302. Validating training data may refer to evaluating the quality or relevance of training data. For example, training data may be validated based on user input via user input workflow 304 and/or with validation datasets 310. User input workflow 304 may involve receiving user input 306, which may include inputs or feedback from a user, such as feedback received through a user interface (e.g., via device 104 or user interface(s) 122). For example, user input 306 may include emissions training data received from a user. User input workflow 304 may also involve input validation 308, which may include data or feedback a user may provide to validate training data. For example, input validation 308 may include review or adjustments of data in training data 302 (e.g., adjusting instances of “Street” or “St.” in the training data to be “St”).

In some embodiments, training data 302 may be validated with validation datasets 310, such as hold-out data that can be used to fine tune models. Validation datasets 310 may include data from various sources or corresponding to different types of emissions data based on training data 302. For example, validation datasets 310 may include validation data corresponding to entity extraction training data, such as internal databases of entities (e.g., facilities, vehicles, equipment) for an organization, address databases (e.g., navigation software), automaker databases, equipment manufacturer databases, or self-reported emissions data. In another example, validation datasets 310 may include validation data corresponding to emissions activity training data or emissions factors training data, such as automaker databases (e.g., Environmental Protection Agency (EPA) Fuel Economy database can provide fuel economy data and CO₂ emissions for light-duty vehicles sold in the U.S. by make, model, and year to help calculate fleet emissions for automakers; ICCT data can include a list of official fuel efficiency and CO₂ emissions databases from regulatory agencies around the world, covering vehicles sold in their jurisdictions, such as data from the U.S., E.U., China, Japan and other major auto markets), equipment manufacturer databases (e.g., EU's CO₂ Monitoring Database, Emissions Analytics' EQUA Index), government equipment databases (e.g., EPAMOVES model or European Environment Agency), or life cycle inventory databases (e.g., U.S. Life Cycle Inventory Database from NREL or Ecoinvent). In an additional example, validation datasets 310 may include validation data corresponding to line item training data (e.g., an internal database of existing line items). Model validation workflow 312 may utilize validation datasets 310 to validate training data and/or model performance. For example, model validation workflow 312 may include extraction validation 314 to validate the extraction of data, as described herein. Extraction validation 314 may include validating extracted data against ground-truth extracted data, such as validated OCR documents. In some embodiments, model validation workflow 312 may be performed by a validation model 316, and the output 318 of validation model 316 may be used to adjust training data 302. For example, validation model 316 may verify the accuracy or consistency of extracted information against source datasets.

In some embodiments, workflow 300 may involve training rules/model engine 320. For example, rules/model engine 320 may be a language model or API endpoint to a language model. Rules/model engine 320 may be trained with user actions (e.g., received from a user interface) and/or data received (e.g., by application system 102). In a first exemplary workflow for rules/model engine 320, the input may be an indication received that the emissions factor used for an emissions calculation has been updated. Rules/model engine 320 may recognize that there has been an update, and compare the new emissions factor to other emissions factor used (e.g., when generating emissions insights for three offices, upon recognizing that the emissions factor for the first office has been changed, rules/model engine 320 may generate an indication or generate a request to change the emissions factors for the remaining two offices). In another exemplary workflow for rules/model engine 320, upon recognizing that a user has performed backfill for certain offices due to gaps in data, rules/model engine 320 may suggest that backfill be completed for other offices, or rules/model engine 320 may automatically complete such backfill. The training for rules/model engine 320 may include learning from user inputs for such recognized actions, such as learning which actions a user may approve. In some embodiments, training data 302 may assist in validating extraction model 322. Extraction model 222 may assist in document understanding and information extraction. For example, extraction model 322 may be a model configured to extract data 324 (e.g., from emissions data sources), such as a transformer-based model and/or a language model. Extraction model 222 may assist in multimodal processing of text or images, handle heterogenous file types, and/or assist in extracting structured data from forms or tables. Additionally, model validation workflow 312 may assist in validating outputs 326 of extraction model 322. In some embodiments, workflow 300 may involve storing outputs 326 in emissions data storage 328.

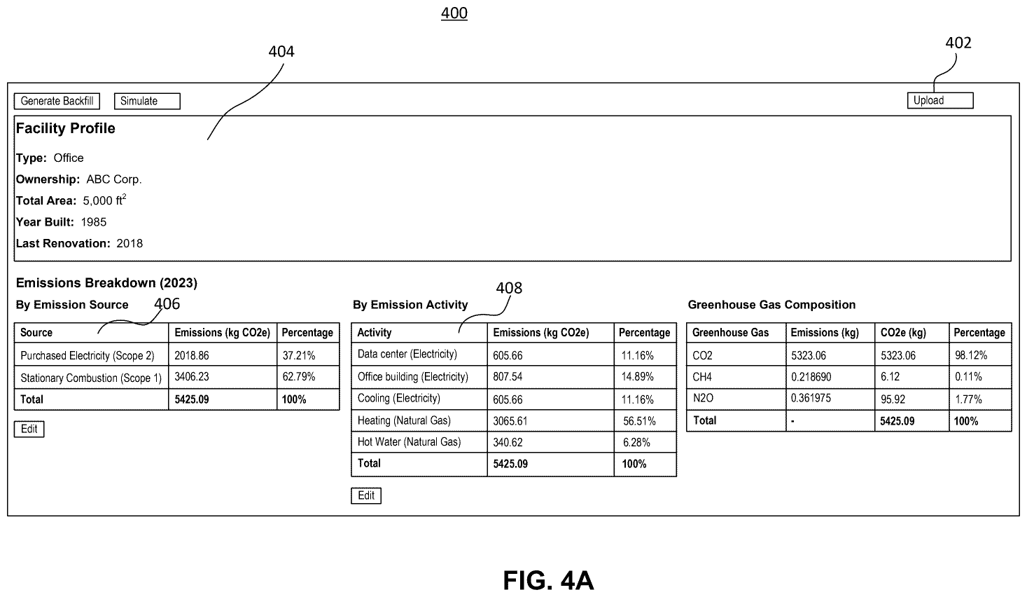

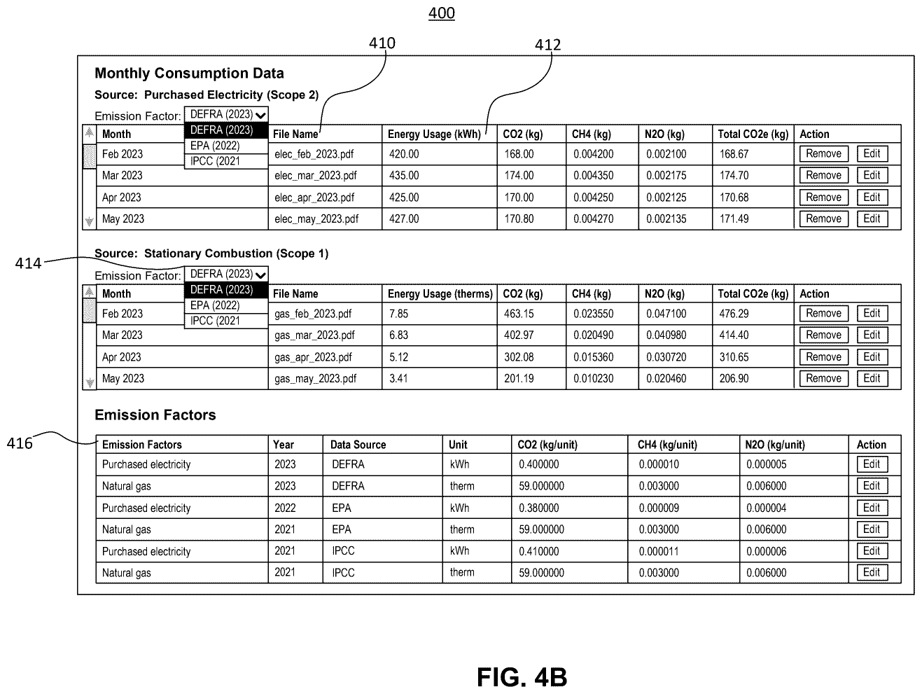

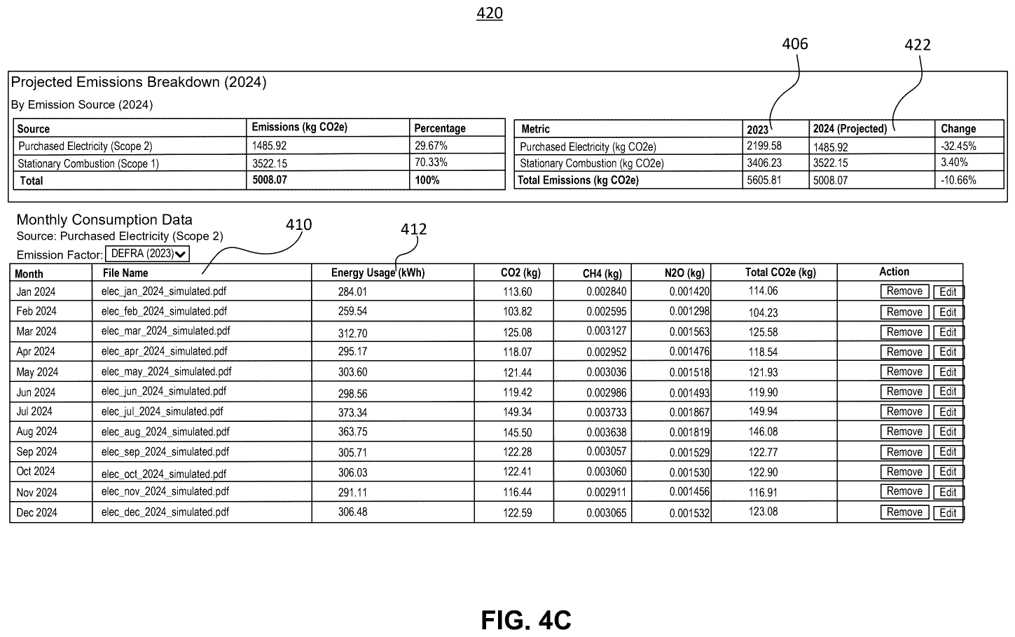

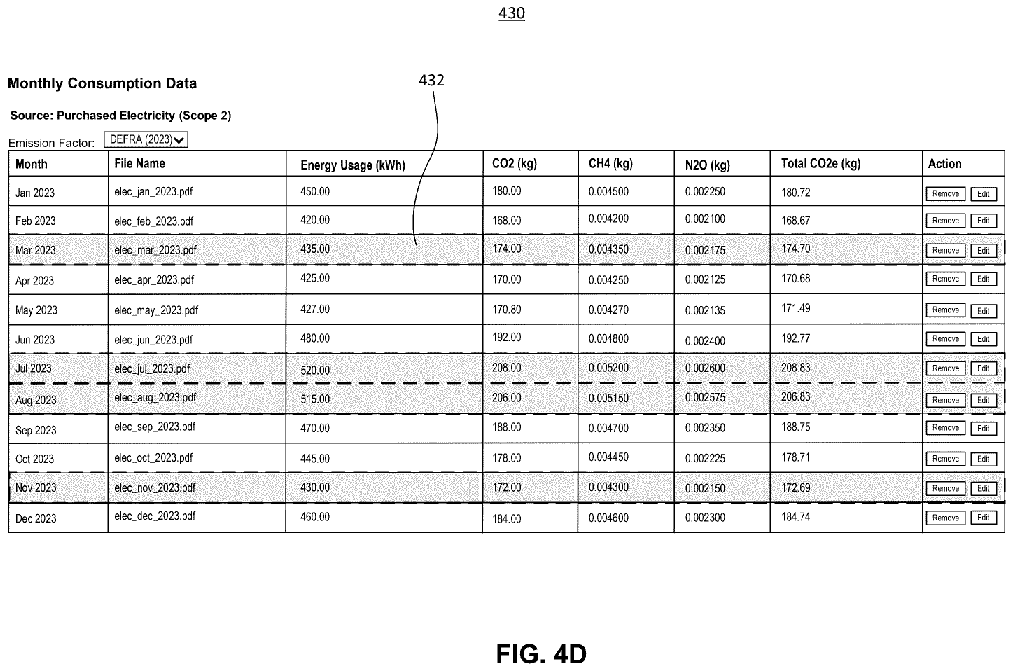

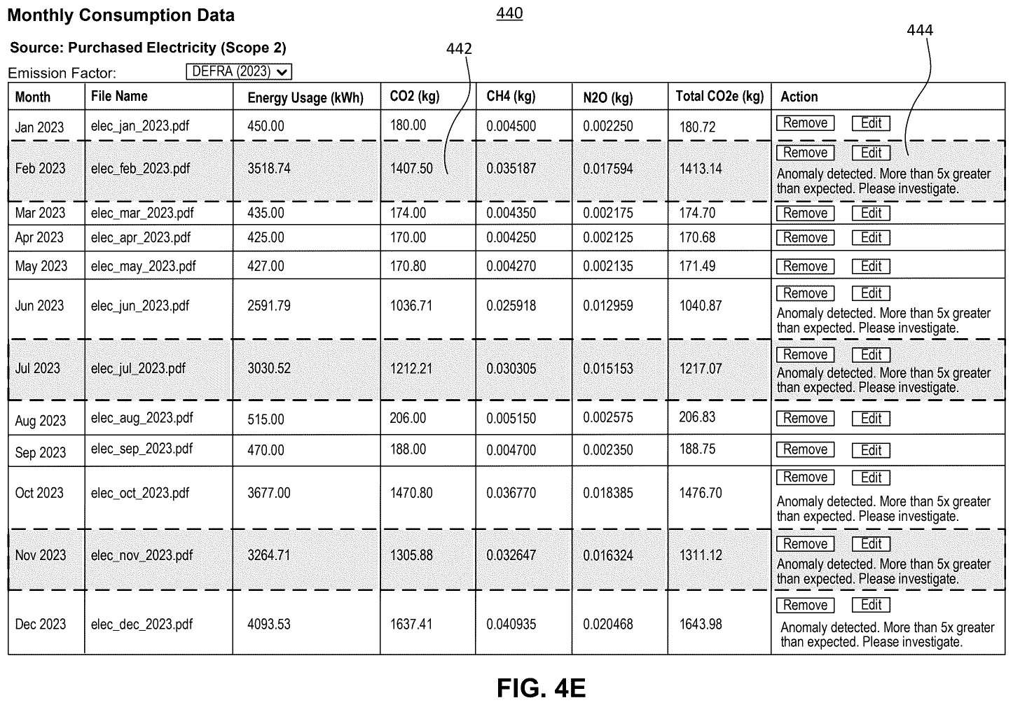

FIGS. 4A-4E illustrate exemplary user interfaces for emissions insights, consistent with embodiments of the present disclosure. FIGS. 4A-4B illustrate an exemplary user interface 400. As an example, user interface 400 may be a user interface of user interface(s) 122. User interface 400 may be an interactive dashboard for emissions insights corresponding to a facility. User interface 400 may include a document upload field 402, which may allow for structured or unstructured (e.g., raw) emissions data to be uploaded to application system 102. For example, upload field 402 may interface with device 104 to receive documents containing emissions data. Application system 102 may analyze the emissions data and extract structured emissions data, as described herein (e.g., with ingestion module(s) 112 and/or machine learning model(s) 110). The extracted emissions data may be displayed in user interface 400. User interface 400 may include a profile field 404. For example, profile field 404 may provide an overview of an emission entity, such as the address, size, and purpose of a facility, the make and model of a vehicle in a fleet, or the like. Emissions source field 406 may display emissions sources extracted from emissions data. For example, emissions source field 406 may include processes that release greenhouse gas emissions categorized by scope to provide emissions insights. Emissions activity field 408 may include activities releasing greenhouse gas emissions, such as cooling or heating for a facility, to provide emissions insights. User interface 400 may include a data source field 410 including information corresponding to the origin of emissions data. For example, data source field 410 may display the name of the file used to generate emissions data or display a hyperlink to the file itself. User interface 400 may include an emissions line item field 412. As described herein, an emissions line item may provide emissions insights for a period of time, such as the energy usage in a given month for a facility. Emissions factor selection field 414 may display the emissions factor(s) and/or emissions factor database(s) used to generate an emissions line item. For example, emissions factor selection field 414 may indicate that the emissions factor database selected for generating the emissions line item corresponds to DEFRA (Department for Environment Food and Rural Affairs). Additionally, or alternatively, emissions factor selection field 414 may allow a user to select a desired emissions factor or emissions factor database, such as selecting between DEFRA, EPA, or IPCC (Intergovernmental Panel on Climate Change). Emissions factor field 416 may list the emissions factors available for various emissions activities. For example, emissions factor filed 416 may indicate which emissions factors have been selected for generating an emission line item.

FIG. 4C illustrates a user interface 420 corresponding to simulated emissions data, consistent with embodiments of the present disclosure. User interface 420 may display data corresponding to a simulation of a forecast (e.g., future projection) of emissions data. User interface 420 may display projected emissions based on past data. For example, machine learning model(s) 110 or analytics module(s) 118 may generate a projection for a future period's emissions (e.g., 2024 emissions) based on past emissions (e.g., 2023 emissions). The emissions projections may be generated based on selected emissions factor(s) and/or emissions factor database(s). A forecast may include projections of emissions line items for a future year and may generate files containing simulated values. For example, user interface 420 may include simulated line item field 412 and simulated data source field 410. User interface 420 may display emissions insights by comparing projected emissions to current or past emissions, such as a comparison between projected emissions source field 422 and emissions source field 406. It will be appreciated that the information displayed in user interface 420 may provide emissions insights by modeling various scenarios. For example, user interface 420 may allow a user to interact and adjust parameters such as emissions activity, emissions factors, business changes, or emissions reductions initiatives to assess impacts on future emissions. For example, projected emissions source field 422 may display forecasted emissions based on a simulation that a solar system has been installed while maintaining the past data in emissions source field 410.

FIG. 4D illustrates a user interface 430 corresponding to simulated emissions data, consistent with embodiments of the present disclosure. User interface 430 may display data corresponding to a simulation of a backfill (e.g., retroactive projection) of emissions data. For example, some emissions data may be incomplete, such as when emissions data for the year 2023 may be missing certain months, such as March, July, August, or November. Additionally, or alternatively, emissions data may include anomalous data, such as when data for one of the above months may be an outlier (e.g., due to extreme weather in a given month). It will be recognized that missing or outlier data may impact the accuracy of emissions insights. Accordingly, the disclosed embodiments may include backfill to replace or fill in certain data. User interface 430 may display projected backfill emissions based on past trends. For example, machine learning model(s) 110 or analytics module(s) 118 may generate a projection for various missing months of 2023 based on the data from other months. Backfill emissions field(s) 432 may include the simulated emissions data for months such as March, July, August, and November in the example. Backfill emissions field(s) 432 may include an emissions line item of the simulated emissions data. The emissions backfill may also be generated based on selected emissions factor(s) and/or emissions factor database(s). Thus, it will be appreciated that through backfill, the disclosed embodiments may provide improvements to the accuracy of generated emissions insights.

FIG. 4E illustrates a user interface 440 corresponding to anomaly detection for emissions data, consistent with embodiments of the present disclosure. User interface 440 may display emissions data and indicate anomalies detected in emissions data, such as with anomaly identification field(s) 442. Anomaly identification field(s) 442 may identify data points determined to be possible anomalies, such as emissions data for a month that may be an outlier. For example, anomaly identification field(s) 442 may include an anomaly indication 444 in an emissions line item. As described herein, anomalies can be determined through statistical methods or machine learning methods, such as comparing a value to previous trends, simulated trends, baseline data, or expected data. Anomalies may be identified upon exceeding a certain threshold, which can be adjusted (e.g., a user may adjust the threshold). For example, anomaly indication 444 may include a message or warning that emissions data has been determined to be greater than 2, 3, or 5 times a baseline value or predicted value. User interface 440 may present anomaly indication 444 as a message to a user.

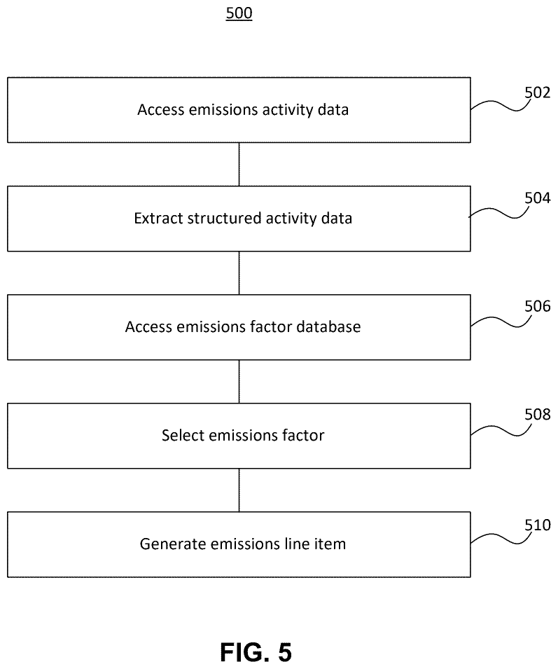

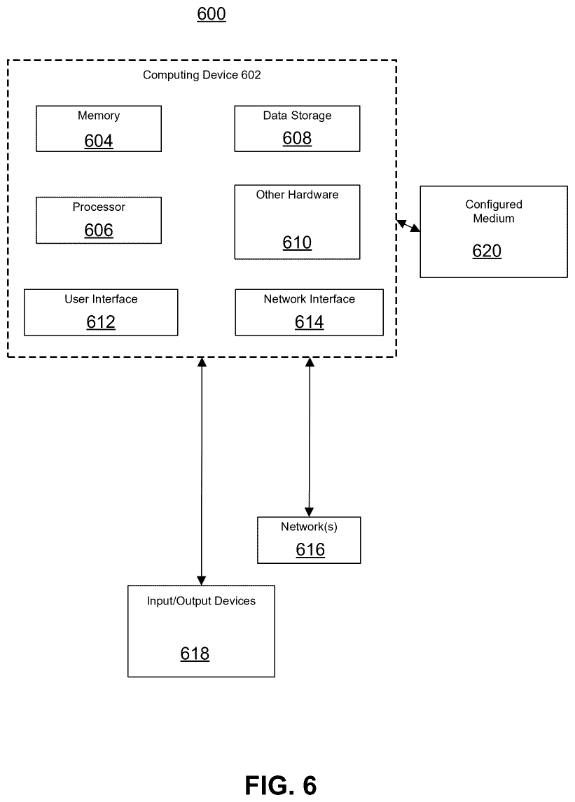

FIG. 5 illustrates a flow chart of a method 500 for analyzing emissions data, consistent with embodiments of the present disclosure. For convenience of description, method 500 may be described herein as being performed by a computer, such as computing device 602 as referenced in FIG. 6. However, the disclosed embodiments are not so limited. In some embodiments, method 500 may be performed by application system 102. In some embodiments, method 500 may be performed by one or more processors, microprocessors, or computing systems. For example, method 500 may be performed by processor 606. Furthermore, the computer(s) used for training machine learning models described herein may differ or be separate from the computer(s) used to obtain the training data, the computer(s) used to generate the training dataset, or the computer(s) which may use the machine learning model for inference.

In some embodiments, method 500 may include a step 502 of accessing emissions activity data. Accessing emissions activity data may include obtaining, receiving, transmitting, or generating emissions activity data, as described herein. In some embodiments, emissions activity data may be accessed from one or more emission activity data sources. An emissions activity data source may include documents, sensors, or endpoints which may provide emissions activity data. For example, emissions activity data sources may include files (e.g., utility bills, purchase records, activity logs, invoices), meters, sensors, or the like. In some embodiments, an emissions activity data source may include device 104. For example, emissions activity data sources may include IoT sensors or API endpoints to emissions accounting systems accessed through device 104, as described herein. In some embodiments, emission activity data may correspond to an emissions entity. For example, an emissions entity may include an office building with an address, as described herein. In some embodiments, the emissions activity data, or the emissions activity data source, may correspond to an activity region. An activity region may be the region or geographic location of emissions activity data for an emission activity. For example, an activity region may be a city, state, country, or the like. Additionally, or alternatively, an emissions region may be determined according to an operational boundary (e.g., of a company or organization) or a specific emissions grid or zone. The activity region may describe where the emission activity data originates from. For example, the emissions activity data source may be a utility invoice for factories within one state for an international corporation. In some examples, emissions activity data sources may correspond to a plurality of activity regions, such as a plurality of states or countries.

In some embodiments, method 500 may include a step 504 of extracting structured emissions data. Structured emissions data may include emissions data that has been standardized or normalized, such as to have consistent units, formats (e.g., file formats) or reported information (e.g., reporting by CO₂ vs CH₄). Structured emissions data may also be organized in a particular manner, such as having labelled data fields. As an example, data ingestion module(s) 112 may assist in extracting structured emissions data. In some embodiments, structured emission data may be extracted from emissions activity data. Extracting structured emissions data may involve applying the emissions activity data to a machine learning model, such as any machine learning model capable of standardizing data. For example, emissions activity data may be applied to a machine learning model including a convolutional neural network (e.g., to process image-based inputs), a transformer model (e.g., for natural language processing of text inputs), a deep neural network (e.g., for analyzing and correlating multidimensional emissions data), or any model described herein (e.g., a model of model(s) 110). In some embodiments, the machine learning model may be trained with emissions training data, as described herein. The emissions activity data may be an input to a model, and the model may use NLP, OCR, image recognition, or other techniques described herein to process the activity data. The model may extract the structured data by converting the emissions activity data into a structured format, such as by reorganizing, reformatting, or standardizing the data. It will be recognized that conventional systems may suffer when generating insights from unstructured data, as analyzing or processing unstructured data can involve greater computational resources, such as more memory or processing power, as well as higher costs. By extracting structured emissions data using machine learning models, it will be appreciated that the disclosed embodiments provide an enhanced ability to generate insights from emissions data, including by reducing computational resource requirements. Further, extracting structured data may assist in resolving inconsistencies, errors, or variabilities across data sources that may hinder emissions insights. Moreover, emissions data may include intricate data types or large volumes of data. Structuring such data may involve computationally-complex tasks such as recognizing patterns or relationships in data as well as processing multidimensional data (e.g., data varying across time and location). It will be appreciated that the disclosed embodiments can handle such computationally-complex tasks efficiently through the use of machine learning models and may be able to handle large amounts of data at scale.

In some embodiments, method 500 may include a step 506 of accessing one or more emissions factor databases. An emissions factor database may contain one or more emissions factors, as described herein. For example, step 506 may involve accessing an emissions factor of emission factor database(s) 107. Emissions factor databases may include public databases, such as a publicly-accessible database. For example, a public emissions factor database may correspond to an emissions schema. An emissions schema may include an organization or classification used to report emissions and can include details on how emissions may be tracked, calculated, or collected. For example, an emissions schema may be aligned with the Greenhouse Gas Protocol. Emissions schemas may categorize emissions according to emissions scopes (e.g., Scope 1, Scope 2, or Scope 3). For example, a public emissions factor database may include emissions factors determined by government or regulatory bodies according to various schemas. In some embodiments, an emissions factor database may include a proprietary database. As described herein, a proprietary database may refer to a private or custom database, such as a database created for a specific organization or business. In some examples, emissions factor databases, including both public and private databases, may include proprietary emissions factors. For example, an emissions factor database for a country may include a custom emissions factor tailored for the country, or an emissions factor database for a company may include custom emissions factors tailored for emissions data exclusive to the company.

In some embodiments, step 506 may involve identifying an emissions factor database to utilize based on a machine learning model. A machine learning model (e.g., a model of model(s) 110) may identify one or more appropriate emissions factor databases (e.g., of emissions factor database(s) 107) based on the structured emissions data. For example, a machine learning model may analyze the information in the structured emissions data to determine whether the type of emissions matches the emissions schema of the emissions factor database. A machine learning model may access various databases of emissions factor database(s) 107 to determine if a given database should be used for emissions analysis. Step 506 may involve determining if various databases satisfy various exemplary conditions, such as determining if an emissions factor database meets a threshold for certain for data quality, whether the emission factor database complies with reporting standards or regulations for the emissions source in the emissions activity data, whether the emissions factor database covers the appropriate emissions scope, or the like. Based on the analysis, one or more emissions factor databases may be identified by the machine learning model as appropriate or containing emissions factors relevant to the structured emissions data. Additionally, or alternatively, appropriate emissions factor databases may be identified based on a user input (e.g., receiving an input of the database(s) to use from a user interface).

In some embodiments, method 500 may include a step 508 of selecting an emissions factor. Step 508 may include selecting an emissions factor from an emissions factor database, such as an emissions factor database accessed in step 506. For example, step 508 may involve selecting an emissions factor from emissions factor database(s) 107. The emissions factor may correspond to the activity region of the emissions activity data and/or of the emissions activity data source. For example, step 508 may involve selecting an emissions factor based on the geographic location of the source of the emissions activity data, or selecting multiple emissions factors corresponding based on the determination that the structured emissions data originates from multiple regions. In some embodiments, emissions factors may be selected based on a user input (e.g., an input received from a user interface). Additionally, or alternatively, step 708 may include selecting one or more emissions factors with a machine learning model (e.g., of model(s) 110). It will be recognized that analyzing emissions factors across a variety of emissions databases may be challenging, as there may be many different emissions factors stored in databases. However, it will be appreciated that the disclosed embodiments provide improvements in selecting emission factors, thereby providing improvements in generating emissions insights by using more accurate emissions factors. A machine learning model may select emissions factors based on information in the structured emissions data. For example, emissions factors may be selected based on information in the structured emissions data, such as fuel type, time frame, recency of the emissions factors, geographic location, industry type, or regulations governing the industry, as non-limiting examples, as well as relevancy to an entity's size or operational characteristics. A machine learning model may efficiently analyze large amounts of emissions factors and select one or more appropriate emissions factors based on such exemplary characteristics such that the selected factors align with the data. It will be appreciated that utilizing a machine learning model to select one or more emissions factors may reduce error in the selection of emissions factors by enabling a larger volume of emission factors to be analyzed as well as evaluating the fit of an emissions factor for given structured emissions data.

In some embodiments, method 500 may include a step 510 of generating an emissions line item. As described herein, an emissions line item may be a quantitative measure of emissions activities for a certain time period. An emissions line item may be used to generate emissions insights, such as summaries of the highest emissions-producing activities or how to focus efforts to mitigate emissions production, as described herein. For example, a line item may include the time frame or dates for an emissions activity, a file name corresponding to the emission entity, the energy usage (e.g., kWh for electricity or BTU for gas), CO₂, CH₄, or N₂O emissions (e.g., measured in kilograms), or total carbon dioxide equivalent (Co₂e). Step 510 may include generating an emissions line item based on structured emissions data and one or more emissions factors (e.g., selected in step 708). Generating an emissions line item may involve applying an emissions factor to the structured emissions data. For example, a selected emissions factor may be a coefficient applied to a specific emissions producing activity for a facility. It will be appreciated that by reducing errors in selecting emissions factors and extracting structured emissions data, the disclosed embodiments provide improved accuracy in generated emissions line items, thereby enabling greater accuracy in emissions insights. In some embodiments, step 510 may also involve displaying an emissions line item on a user interface (e.g., of user interface(s) 122).

In some embodiments, step 510 may include generating emissions line items according to activity region. For example, structured emissions data may include emissions from multiple sources or emissions produced in multiple activity regions, such as a single utility bill covering purchased electricity across facilities in different states. The disclosed embodiments may involve generating multiple emissions line items by selecting multiple emissions factors, as described herein, for differing activity regions. Based on determining differing activity regions in the structured emissions data, emissions factors corresponding to each activity region can be selected. Thus, a plurality of emissions line items may be generated according to different emissions factors and thereby different activity regions. Therefore, it will be appreciated that some disclosed embodiments enable emissions analysis organized or segmented by geographic region, providing improved emissions insights across regions.

An exemplary operating environment for implementing various aspects of this disclosure is illustrated in FIG. 6. As illustrated in FIG. 6, an exemplary operating environment 600 may include a computing device 602 (e.g., a general-purpose computing device) in the form of a computer. Components of the computing device 602 may include, but are not limited to, various hardware components, such as one or more processors 606, data storage 608, a system memory 604, other hardware 610, and a system bus (not shown) that couples (e.g., communicably couples, physically couples, and/or electrically couples) various system components such that the components may transmit data to and from one another. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

With further reference to FIG. 6, an operating environment 600 for an exemplary embodiment includes at least one computing device 602. The computing device 602 may be a uniprocessor or multiprocessor computing device. An operating environment 600 may include one or more computing devices (e.g., multiple computing devices 602) in a given computer system, which may be clustered, part of a local area network (LAN), part of a wide area network (WAN), client-server networked, peer-to-peer networked within a cloud, or otherwise communicably linked. A computer system may include an individual machine or a group of cooperating machines. A given computing device 602 may be configured for end-users, e.g., with applications, for administrators, as a server, as a distributed processing node, as a special-purpose processing device, or otherwise configured to train machine learning models and/or use machine learning models.

One or more users may interact with the computer system comprising one or more computing devices 602 by using a display, keyboard, mouse, microphone, touchpad, camera, sensor (e.g., touch sensor) and other input/output devices 618, via typed text, touch, voice, movement, computer vision, gestures, and/or other forms of input/output. An input/output device 618 may be removable (e.g., a connectable mouse or keyboard) or may be an integral part of the computing device 602 (e.g., a touchscreen, a built-in microphone). For example, input/output device 618 may include device 104. A user interface 612 may support interaction between an embodiment and one or more users. A user interface 612 may include one or more of a command line interface, a graphical user interface (GUI), natural user interface (NUI), voice command interface, and/or other user interface (UI) presentations, which may be presented as distinct options or may be integrated. A user may enter commands and information through a user interface or other input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs using hands or fingers, or other NUI may also be used with the appropriate input devices, such as a microphone, camera, tablet, touch pad, glove, or other sensor. These and other input devices are often connected to the processing units through a user input interface that is coupled to the system bus, but may be connected by other interface and bus structures, such as a parallel port, game port or a universal serial bus (USB). A monitor or other type of display device is also connected to the system bus via an interface, such as a video interface. The monitor may also be integrated with a touch-screen panel or the like. Note that the monitor and/or touch screen panel can be physically coupled to a housing in which the computing device is incorporated, such as in a tablet-type personal computer. In addition, computers such as the computing device may also include other peripheral output devices such as speakers and printer, which may be connected through an output peripheral interface or the like.

One or more application programming interface (API) calls may be made between input/output devices 618 and computing device 602, based on input received from at user interface 612 and/or from network(s) 616. As used throughout, “based on” may refer to being established or founded upon a use of, changed by, influenced by, caused by, or otherwise derived from. In some embodiments, an API call may be configured for a particular API, and may be interpreted and/or translated to an API call configured for a different API. As used herein, an API may refer to a defined (e.g., according to an API specification) interface or connection between computers or between computer programs.

System administrators, network administrators, software developers, engineers, and end-users are each a particular type of user. Automated agents, scripts, playback software, and the like acting on behalf of one or more people may also constitute a user. Storage devices and/or networking devices may be considered peripheral equipment in some embodiments and part of a system comprising one or more computing devices 602 in other embodiments, depending on their detachability from the processor(s) 606. Other computerized devices and/or systems not shown in FIG. 6 may interact in technological ways with computing device 602 or with another system using one or more connections to a network 616 via a network interface 614, which may include network interface equipment, such as a physical network interface controller (NIC) or a virtual network interface (VIF).

Computing device 602 includes at least one logical processor 606. The at least one logical processor 606 may include circuitry and transistors configured to execute instructions from memory (e.g., memory 604). For example, the at least one logical processor 606 may include one or more central processing units (CPUs), arithmetic logic units (ALUs), Floating Point Units (FPUs), and/or Graphics Processing Units (GPUs). The computing device 602, like other suitable devices, also includes one or more computer-readable storage media, which may include, but are not limited to, memory 604 and data storage 608. In some embodiments, memory 604 and data storage 608 may be part a single memory component. The one or more computer-readable storage media may be of different physical types. The media may be volatile memory, non-volatile memory, fixed in place media, removable media, magnetic media, optical media, solid-state media, and/or of other types of physical durable storage media (as opposed to merely a propagated signal). In particular, a configured medium 620 such as a portable (i.e., external) hard drive, compact disc (CD), Digital Versatile Disc (DVD), memory stick, or other removable non-volatile memory medium may become functionally a technological part of the computer system when inserted or otherwise installed with respect to one or more computing devices 602, making its content accessible for interaction with and use by processor(s) 606. The removable configured medium 620 is an example of a computer-readable storage medium. Some other examples of computer-readable storage media include built-in random access memory (RAM), read-only memory (ROM), hard disks, and other memory storage devices which are not readily removable by users (e.g., memory 604).

The configured medium 620 may be configured with instructions (e.g., binary instructions) that are executable by a processor 606; “executable” is used in a broad sense herein to include machine code, interpretable code, bytecode, compiled code, and/or any other code that is configured to run on a machine, including a physical machine or a virtualized computing instance (e.g., a virtual machine or a container). The configured medium 620 may also be configured with data which is created by, modified by, referenced by, and/or otherwise used for technical effect by execution of the instructions. The instructions and the data may configure the memory or other storage medium in which they reside; such that when that memory or other computer-readable storage medium is a functional part of a given computing device, the instructions and data may also configure that computing device.

Although an embodiment may be described as being implemented as software instructions executed by one or more processors in a computing device (e.g., general-purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include other hardware logic components 610 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processor(s) 606, memory 604, data storage 608, and screens/displays, an operating environment may also include other hardware 610, such as batteries, buses, power supplies, wired and wireless network interface cards, for instance. The nouns “screen” and “display” are used interchangeably herein. A display may include one or more touch screens, screens responsive to input from a pen or tablet, or screens which operate solely for output. In some embodiment, other input/output devices 618 such as human user input/output devices (screen, keyboard, mouse, tablet, microphone, speaker, motion sensor, etc.) will be present in operable communication with one or more processors 606 and memory.

In some embodiments, the system includes multiple computing devices 602 connected by network(s) 616. Networking interface equipment can provide access to network(s) 616, using components (which may be part of a network interface 614) such as a packet-switched network interface card, a wireless transceiver, or a telephone network interface, for example, which may be present in a given computer system. However, an embodiment may also communicate technical data and/or technical instructions through direct memory access, removable non-volatile media, or other information storage-retrieval and/or transmission approaches.

The computing device 602 may operate in a networked or cloud- computing environment using logical connections to one or more remote devices (e.g., using network(s) 616), such as a remote computer (e.g., another computing device 602). The remote computer may include one or more of a personal computer, a server, a router, a network PC, or a peer device or other common network node, and may include any or all of the elements described above relative to the computer. The logical connections may include one or more LANs, WANs, and/or the Internet.

When used in a networked or cloud-computing environment, computing device 602 may be connected to a public or private network through a network interface or adapter. In some embodiments, a modem or other communication connection device may be used for establishing communications over the network. The modem, which may be internal or external, may be connected to the system bus via a network interface or other appropriate mechanism. A wireless networking component such as one comprising an interface and antenna may be coupled through a suitable device such as an access point or peer computer to a network. In a networked environment, program modules depicted relative to the computer, or portions thereof, may be stored in the remote memory storage device. It may be appreciated that the network connections shown are exemplary and other means of establishing a communications link between the computers may be used.

Computing device 602 typically may include any of a variety of computer-readable media. Computer-readable media may be any available media that can be accessed by the computer and includes both volatile and nonvolatile media, and removable and non-removable media, but excludes propagated signals. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, electrically erasable programmable read-only memory (EEPROM), flash memory or other memory technology, CD-ROM, DVD or other optical disk storage, magnetic cassettes, magnetic tape, magnetic disk storage or other magnetic storage devices, or any other medium which can be used to store the desired information (e.g., program modules, data for a machine learning model, and/or a machine learning model itself) and which can be accessed by the computer. Communication media may embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of the any of the above may also be included within the scope of computer-readable media. Computer-readable media may be embodied as a computer program product, such as software (e.g., including program modules) stored on non-transitory computer-readable storage media.

The data storage 608 or system memory includes computer storage media in the form of volatile and/or nonvolatile memory such as ROM and RAM. A basic input/output system (BIOS), containing the basic routines that help to transfer information between elements within computer, such as during start-up, may be stored in ROM. RAM may contain data and/or program modules that are immediately accessible to and/or presently being operated on by processing unit. By way of example, and not limitation, data storage holds an operating system, application programs, and other program modules and program data.

Data storage 608 may also include other removable/non-removable, volatile/nonvolatile computer storage media. By way of example only, data storage may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

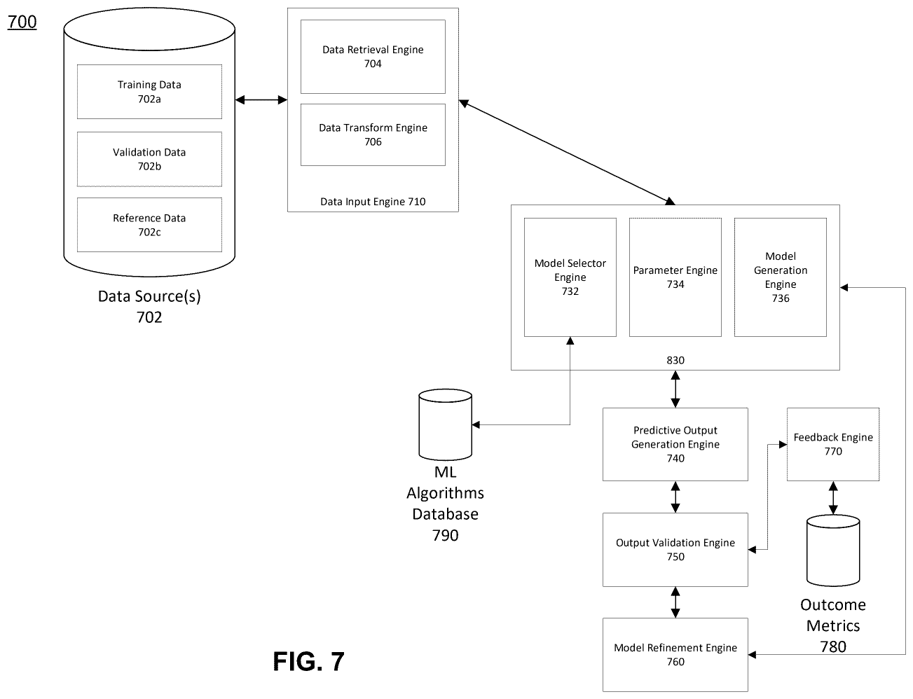

Exemplary disclosed embodiments include systems, methods, and computer readable media for the generation of text and/or code embeddings. For example, in some embodiments, and as illustrated in FIG. 6, an operating environment 600 may include at least one computing device 602, the at least one computing device 602 including at least one processor 606, at least one memory 604, at least one data storage 608, and/or any other component discussed above with respect to FIG. 7.

FIG. 7 is a block diagram illustrating an exemplary machine learning platform for implementing various aspects of this disclosure, according to some embodiments of the present disclosure.

System 700 may include data input engine 710 that can further include data retrieval engine 704 and data transform engine 706. Data retrieval engine 704 may be configured to access, access, interpret, request, or receive data, which may be adjusted, reformatted, or changed (e.g., to be interpretable by other engine, such as data input engine 710). For example, data retrieval engine 704 may request data from a remote source using an API. Data Input engine 710 may be configured to access, interpret, request, format, re-format, or receive input data from data source(s) 702. For example, data input engine 710 may be configured to use data transform engine 706 to execute a re-configuration or other change to data, such as a data dimension reduction. Data source(s) 702 may exist at one or more memories 604 and/or data storages 608. In some embodiments, data source(s) 702 may be associated with a single entity (e.g., organization) or with multiple entities. Data source(s) 702 may include one or more of training data 702a (e.g., input data to feed a machine learning model as part of one or more training processes), validation data 702b (e.g., data against which at least one processor may compare model output with, such as to determine model output quality), and/or reference data 702c. For example, training data 702a, validation data 702b, and/or reference data 702c may include data domains, as described herein. In some embodiments, data input engine 710 can be implemented using at least one computing device (e.g., computing device 602). For example, data from data sources 702 can be obtained through one or more I/O devices and/or network interfaces. Further, the data may be stored (e.g., during execution of one or more operations) in a suitable storage or system memory. Data input engine 710 may also be configured to interact with data storage 608, which may be implemented on a computing device that stores data in storage or system memory. System 700 may also include machine learning (ML) modeling engine 730, which may be configured to execute one or more operations on a machine learning model (e.g., model training, model re-configuration, model validation, model testing), such as those described in the processes described herein. In an example, machine learning modeling engine 730 may include a machine learning of model(s) 110, as referenced in FIG. 1. For example, ML modeling engine 730 may execute an operation to train a machine learning model, such as adding, removing, or modifying a model parameter. Training of a machine learning model may be supervised, semi-supervised, or unsupervised. In some embodiments, training of a machine learning model may include multiple epochs, or passes of data (e.g., training data 702a) through a machine learning model process (e.g., a training process). In some embodiments, different epochs may have different degrees of supervision (e.g., supervised, semi-supervised, or unsupervised). Data into to a model to train the model may include input data (e.g., as described above) and/or data previously output from a model (e.g., forming recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed embodiments in any way, a machine learning model may include millions, trillions, or even billions of model parameters. ML modeling engine 730 may include model selector engine 732 (e.g., configured to select a model from among a plurality of models, such as based on input data), parameter selector engine 734 (e.g., configured to add, remove, and/or change one or more parameters of a model), and/or model generation engine 736 (e.g., configured to generate one or more machine learning models, such as according to model input data, model output data, comparison data, and/or validation data). ML algorithms database 780 (or other data storage 608) may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein.

System 700 can further include predictive output generation engine 740, output validation engine 750 (e.g., configured to apply validation data to machine learning model output), feedback engine 770 (e.g., configured to apply feedback from a user and/or machine to a model), and model refinement engine 760 (e.g., configured to update or re-configure a model). In some embodiments, feedback engine 770 may receive input and/or transmit output (e.g., output from a trained, partially trained, or untrained model) to outcome metrics database 780. Outcome metrics database 780 may be configured to store output from one or more models, and may also be configured to associate output with one or more models. In some embodiments, outcome metrics database 780, or other device (e.g., model refinement engine 760 or feedback engine 770) may be configured to correlate output, detect trends in output data, and/or infer a change to input or model parameters to cause a particular model output or type of model output. In some embodiments, model refinement engine 760 may receive output from predictive output generation engine 740 or output validation engine 750. In some embodiments, model refinement engine 760 may transmit the received output to ML modelling engine 730 in one or more iterative cycles.

Any or each engine of system 700 may be a module (e.g., a program module), which may be a packaged functional hardware unit designed for use with other components or a part of a program that performs a particular function (e.g., of related functions). Any or each of these modules may be implemented using a computing device. In some embodiments, the functionality of system 700 may be split across multiple computing devices to allow for distributed processing of the data, which may improve output speed and reduce computational load on individual devices. In some embodiments, system 700 may use load-balancing to maintain stable resource load (e.g., processing load, memory load, or bandwidth load) across multiple computing devices and to reduce the risk of a computing device or connection becoming overloaded. In these or other embodiments, the different components may communicate over one or more I/O devices and/or network interfaces.

System 700 can be related to different domains or fields of use. Descriptions of embodiments related to specific domains, such as natural language processing or language modeling, is not intended to limit the disclosed embodiments to those specific domains, and embodiments consistent with the present disclosure can apply to any domain that utilizes predictive modeling based on available data.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Example embodiments are described above with reference to flowchart illustrations or block diagrams of methods, apparatus (systems) and computer program products. It will be understood that each block of the flowchart illustrations or block diagrams, and combinations of blocks in the flowchart illustrations or block diagrams, can be implemented by computer program product or instructions on a computer program product. These computer program instructions may be provided to a processor of a computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer-readable medium that can direct one or more hardware processors of a computer, other programmable data processing apparatus, or other devices to function in a particular manner, such that the instructions stored in the computer-readable medium form an article of manufacture including instructions that implement the function/act specified in the flowchart or block diagram block or blocks.

The computer program instructions may also be loaded onto a computer, other programmable data processing apparatus, or other devices to cause a series of operational steps to be performed (e.g., executed) on the computer, other programmable apparatus or other devices to produce a computer implemented process such that the instructions that execute on the computer or other programmable apparatus provide processes for implementing the functions/acts specified in the flowchart or block diagram block or blocks.

Any combination of one or more computer-readable medium(s) may be utilized. The computer-readable medium may be a non-transitory computer-readable storage medium. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber cable, RF, IR, etc., or any suitable combination of the foregoing.

Computer program code for carrying out operations, for example, embodiments may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

The flowchart and block diagrams in the figures illustrate examples of the architecture, functionality, and operation of possible implementations of systems, methods, and computer program products according to various embodiments. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

It is understood that the described embodiments are not mutually exclusive, and elements, components, materials, or steps described in connection with one example embodiment may be combined with, or eliminated from, other embodiments in suitable ways to accomplish desired design objectives.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A machine learning system for emissions data analysis, the system comprising:
at least one processor; and
at least one computer-readable medium containing instructions that, when executed by the at least one processor, cause the machine learning system to perform operations comprising:
accessing emissions activity data from at least one emissions activity data source, wherein the emissions activity data corresponds to an entity and the at least one emissions activity data source corresponds to an activity region;
extracting structured emissions data from the emissions activity data by applying the emissions activity data to a machine learning model configured to standardize data, wherein the machine learning model is trained with emissions training data;
accessing an emissions factor database containing a plurality of emissions factors;
selecting, from the emissions factor database, at least one emissions factor corresponding to the activity region; and
generating an emissions line item based on the structured emissions data and the at least one selected emissions factor.

2. The system of claim 1, wherein the emissions factor database comprises a public database.

3. The system of claim 2, wherein the emissions factor database corresponds to an emissions schema.

4. The system of claim 1, wherein the emissions factor database comprises a proprietary database or the at least one emissions factor comprises a proprietary emissions factor.

5. The system of claim 1, wherein the operations further comprise:
identifying the emissions factor database with the machine learning model; and
selecting, with the machine learning model, the at least one emissions factor from the identified emissions factor database.

6. The system of claim 1, wherein the operations further comprise:
receiving an identification of the emissions factor database from a user interface; and
selecting the at least one emissions factor from the identified emission factor database based on an input received from the user interface.

7. The system of claim 1, wherein the emissions training data is entity-specific, and wherein the emissions training data comprises at least one of emissions entity training data or emissions activity training data.

8. The system of claim 1, wherein training the machine learning model comprises:
obtaining the emissions training data;
receiving user input from a user interface; and
updating the machine learning model based on the emissions training data and the user input.

9. The system of claim 1, wherein the operations further comprising generating a user interface and displaying the generated emissions line item on the user interface.

10. The system of claim 1, wherein the operations further comprise:
selecting, from the emissions factor database, emissions factors corresponding to a plurality of activity regions; and
generating emissions line items based on the structured emissions data and the plurality of selected emissions factors.

11. A computer-implemented method of analyzing emissions data, comprising:
accessing emissions activity data from at least one emissions activity data source, wherein the emissions activity data corresponds to an entity and the at least one emissions activity data source corresponds to an activity region;
extracting structured emissions data from the emissions activity data by applying the emissions activity data to a machine learning model configured to standardize data, wherein the machine learning model is trained with emissions training data;
accessing an emissions factor database containing a plurality of emissions factors;
selecting, from the emissions factor database, at least one emissions factor corresponding to the activity region; and
generating an emissions line item based on the structured emissions data and the at least one selected emissions factor.

12. The method of claim 11, wherein the emissions factor database comprises a public database.

13. The method of claim 12, wherein the emissions factor database corresponds to an emissions schema.

14. The method of claim 11, wherein the emissions factor database comprises a proprietary database or the at least one emissions factor comprises a proprietary emissions factor.

15. The method of claim 11, further comprising:
identifying the emissions factor database with the machine learning model; and
selecting, with the machine learning model, the at least one emissions factor from the identified emissions factor database.

16. The method of claim 11, further comprising:
receiving an identification of the emissions factor database from a user interface; and
selecting the at least one emissions factor from the identified emission factor database based on an input received from the user interface.

17. The method of claim 11, wherein the emissions training data comprises at least one of emissions entity training data or emissions activity training data.

18. The method of claim 11, wherein training the machine learning model comprises:
obtaining the emissions training data;
receiving user input from a user interface; and
updating the machine learning model based on the emissions training data and the user input.

19. The method of claim 11, further comprising generating a user interface and displaying the generated emissions line item on the user interface.

20. A non-transitory computer-readable medium including instructions that are executable by one or more processors to perform operations comprising:
accessing emissions activity data from at least one emissions activity data source, wherein the emissions activity data corresponds to an entity and the at least one emissions activity data source corresponds to an activity region;
extracting structured emissions data from the emissions activity data by applying the emissions activity data to a machine learning model configured to standardize data, wherein the machine learning model is trained with emissions training data;
accessing an emissions factor database containing a plurality of emissions factors;
selecting, from the emissions factor database, at least one emissions factor corresponding to the activity region; and
generating an emissions line item based on the structured emissions data and the at least one selected emissions factor.
